(19) United States
(12) Patent Application Publication
(10) Pub. No.: US 2013/0342689 A1
(43) Pub. Date: Dec. 26, 2013

(54) VIDEO ANALYTICS TEST SYSTEM

(71) Applicants: ADDICAM V. SANJAY, Gilbert, AZ (US); SHAHZAD A. MALIK, Markham (CA); ABHISHEK RANJAN, Toronto (CA); SHWETA PHADNIS, Chandler, AZ (US); JOSE A. AVALOS, Chandler, AZ (US)

(72) Inventors: ADDICAM V. SANJAY, Gilbert, AZ (US); SHAHZAD A. MALIK, Markham (CA); ABHISHEK RANJAN, Toronto (CA); SHWETA PHADNIS, Chandler, AZ (US); JOSE A. AVALOS, Chandler, AZ (US)

(73) Assignee: INTEL CORPORATION, Santa Clara, CA (US)

(21) Appl. No.: 13/531,646

(22) Filed: Jun. 25, 2012

(51) Int. Cl. H04N 7/18

(52) U.S. Cl. 348/143; 348/E07.085

(57) ABSTRACT

Various embodiments are directed to a system for testing a video analytics system. In one embodiment, an apparatus comprises a processor circuit executing a sequence of instructions causing the processor circuit to receive a first data specifying boundaries of a first rectangular region indicated as comprising an image of a face in a video frame of a motion video; receive a second data specifying boundaries of a second rectangular region indicated as comprising an image of a face in the video frame of the motion video; measure a distance between corresponding corners of the first and second rectangular regions; compare the distance to a distance threshold; and determine whether the first and second rectangular regions comprise images of a same face based on the comparison. Other embodiments are described and claimed.

### BACKGROUND

Judging the effectiveness of a visual advertisement in drawing or holding the attention of members of the public, conveying a message succinctly and effectively, etc., presents many challenges. Past efforts involved placing a sample of a visual advertisement in a typical public area and positioning someone to observe the reactions of members of the public to it. However, members of the public are often uncomfortable with knowing that they are being observed, and this knowledge inevitably affects their behavior in reacting to a visual advertisement.

An approach to more discreetly observing members of the public for such purposes has been to position a camera in a manner in which it does not draw attention to itself, but which allows reactions of members of the public to a visual advertisement to be analyzed. Initially, such cameras were employed to allow a person at a remote location to do that analysis. However, it has more recently been deemed desirable to couple such cameras to computing devices equipped with video analytics software to do that analysis.

Still more recently, the advent of relatively inexpensive flat panel displays has resulted in their use in creating visual advertisement systems that rotate through display different visual advertisements at regular intervals. However, the possibility of combining such visual advertisement systems with computing devices employing video analytics software offers the option of creating visual advertisement systems in which reactions of members of the public are analyzed and used as cues to change the visual advertisements that are displayed. Unfortunately, video analytics of faces remains a technology in its infancy leading to a continuing need to conduct effective testing of video analytics systems.

It is with respect to these and other considerations that the techniques described herein are needed.

### BRIEF DESCRIPTION OF THE DRAWINGS

FIG. 1 illustrates an embodiment of a video analytics test system.

FIG. 2 illustrates a portion of the embodiment of FIG. 1.

FIG. 3 illustrates an embodiment of a first logic flow.

FIG. 4 illustrates an embodiment of a second logic flow.

FIG. 5 illustrates an embodiment of a third logic flow.

FIG. 6 illustrates an embodiment of a fourth logic flow.

FIG. 7 illustrates an embodiment of a processing architecture.

### DETAILED DESCRIPTION

Various embodiments are generally directed to a system for testing aspects of a video analytics system. Some embodiments are particularly directed to testing aspects of a video analytics system applied to analyzing motion video of persons interacting with a visual display.

More specifically, a video analytics testing system employs a motion test video having numerous known parameters and simulating an environment into which a video analytics system is installed as an input to test aspects of that video analytics system. The video analytics testing system employs numerous techniques to analyze various aspects of effectiveness of the video analytics system in analyzing features of the test video. At least some of the analysis techniques are specifically structured to evaluate a video analytics system as a device employed to analyze motion video, rather than still photos, to provide greater accuracy in analysis. In some embodiments, the results of such testing may be employed as an input to that video analytics system where that video analytics system is at least partly adaptive.

An advantage of performing such testing in the environment into which a video analytics system is installed and employing a motion test video is obtaining results more reflective of the affects of that environment on the video analytics system, instead of relying on results of tests performed in more idealized and sterile testing conditions prior to installation. Also, an advantage of performing such testing employing motion video, rather than still photos in testing, is to better expose aspects of the effectiveness of a video analytics system that are affected by motion video to a greater degree than by still photos.

In one embodiment, for example, an apparatus comprises a processor circuit and a storage communicatively coupled to the processor circuit, and storing a sequence of instructions that when executed by the processor circuit, causes the processor circuit to: receive a first signal from a first device conveying a first data specifying boundaries of a first rectangular region indicated as comprising an image of a face in a video frame of a motion video; receive a second signal from a second device conveying a second data specifying boundaries of a second rectangular region indicated as comprising an image of a face in the video frame of the motion video; measure a first distance between first corresponding corners of the first and second rectangular regions; compare the first distance to a distance threshold; and determine whether the first and second rectangular regions comprise images of a same face based on the comparison. Other embodiments are described and claimed herein.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may comprise a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

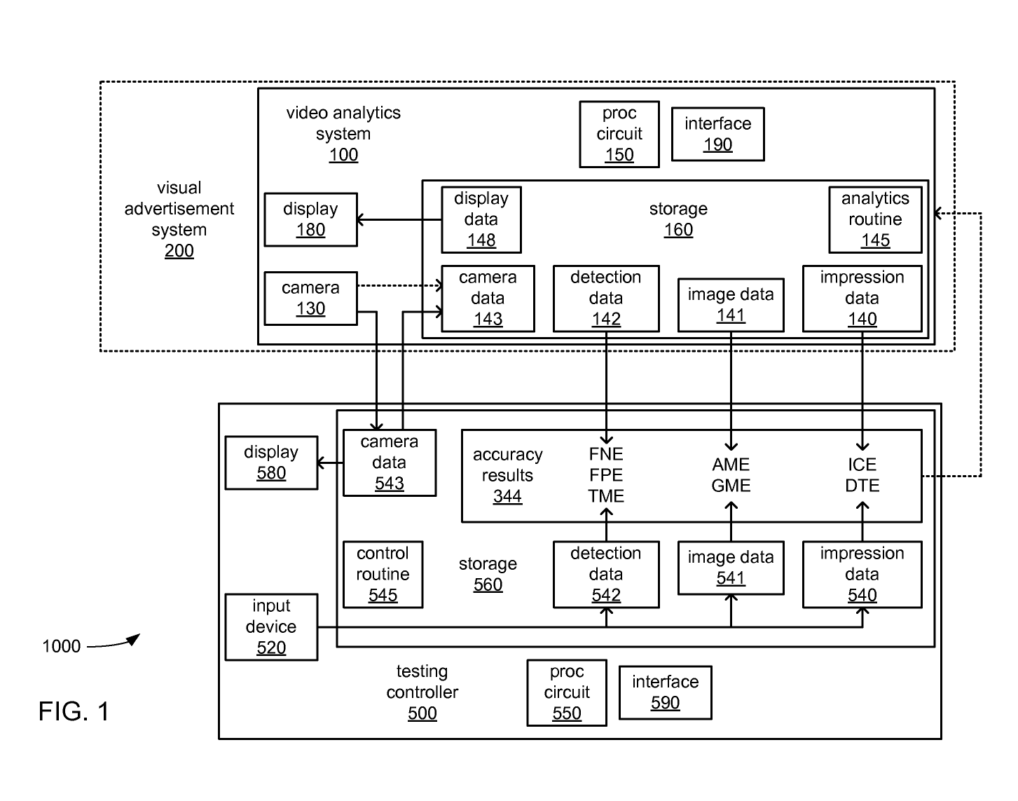

FIG. 1 illustrates a block diagram of a video analytics testing system 1000 comprising a video analytics system 100 and a testing controller 500. Each of the video analytics system 100 and the testing controller 500 may be any of a variety of types of computing device, including without limitation, a desktop computer system, a data entry terminal, a laptop computer, a netbook computer, a tablet computer, a handheld personal data assistant, a smartphone, a body-worn computing device incorporated into clothing, a computing device integrated into a vehicle, etc.

In various embodiments, the video analytics system 100 is a component of a visual advertisement system 200 positioned at a public location to visually display a plurality of visual advertisements on a display 180 of the video analytics system 100. A camera 130 of the video analytics system 100 enables analysis of faces of members of the public to derive aspects of their reactions to the visual advertisements that are visually displayed on the display 180, and possibly use their reactions in making determinations of when to change the visual advertisement being visually displayed and/or of what visual advertisement to visually display next. The visual advertisement system 200 may have any of a variety of physical configurations, including without limitation, stationary (e.g., at an entrance or window of a shop, part of a kiosk in a park or courtyard, etc.), installed on a vehicle (e.g., inside a commuter train to be viewed by its passengers, outside a bus to be viewed by people on a curb, etc.), or mounted on a hand-pushed cart (e.g., attached to a hotdog stand on wheels).

In various embodiments, and as will be explained in greater detail, the video analytics system 100 is set up as part of the visual advertisement system 200 on location where visual advertisements are to be visually displayed. The testing controller 500 is communicatively coupled to the video analytics system 100 to test the accuracy with which the video analytics system 100 identifies and analyzes aspects of faces of persons who come into view of its camera 130 at the location. As part of this testing, a test motion video is created, also at the location and possibly using the camera 130 (or using a separate camera of the testing controller 500 that is co-located with the camera 130 so as to have a similar view), to enable subsequent repeated iterations of testing with the same video input used in each iteration as changes and/or adjustments are made to improve the accuracy of the video analytics system 100 in response to what the testing reveals.

In various embodiments, the video analytics system 100 comprises a storage 160 storing at least an analytics routine 145, a processor circuit 150, an interface 190, and the camera 130. In some embodiments, the video analytics system 100 further comprises the display 180 and/or the storage 160 further stores a display data 148. Also, during operation of the video analytics system 100, the storage 160 is caused to further store a camera data 143, along with one or more of a detection data 142, an image data 141 and an impression data 140 that are created from the camera data 143.

In some embodiments, the video analytics system 100 controls what visual advertisements are visually displayed on the display 180, analyzes faces of members of the public captured by the camera 130 to discern reactions of members of the public to those visual advertisements, and employs the results of these analyses in determining what visual advertisements are to be visually displayed on the display 180, when and/or for how long. In such embodiments, the video analytics system 100 may either comprise the display 180 or be communicatively coupled to it, and may either store the visual advertisements within the storage as the display data 148 or may be communicatively coupled to a separate playing device (not shown) that transmits visual advertisements to the display 180 under the control of the video analytics system 100.

In some of such embodiments, the processor circuit 150 is caused by executing a sequence of instructions of the analytics routine 145 to transmit various visual advertisements stored as part of the display data 148 to the display 180 to be visually displayed, and is caused to receive and buffer video frames of captured motion imagery from the camera 130 as the camera data 143. The processor circuit 150 is also caused to analyze the video frames of motion imagery captured by the camera data 143 to detect images of faces of people in those video frames, and to store results indicating detection of images of faces in the storage 160 as the detection data 142. The processor circuit 150 is further caused to analyze the detected images of faces to determine various characteristics of each image of a face in each video frame, and to store results indicating determined characteristics of each of those images as the image data 141. The processor circuit 150 is also further caused to analyze the detected images of faces to determine various characteristics of behavior of the people associated with those faces, and to store results indicating impressions and dwell time as the impression data 140.

In other embodiments, the video analytics system 100 does not control what visual advertisements are visually displayed on the display 180, and instead, is more limited to analyzing faces of members of the public captured by the camera 130 to discern reactions to whatever visual advertisement may be transmitted to the visual display 180 by an entirely independent playing device (not shown) for being visually displayed. Instead, the video analytics system 100 may be relied upon to provide a report summarizing aspects of the public's reaction to what was visually displayed over a particular period of time. In such embodiments, the video analytics system 100 may neither comprise nor be coupled to the display 180, and the visual advertisements may not be stored within the storage 160 at all. In such embodiments, the processor circuit 150 does much of what has just earlier been described regarding analyzing imagery captured by the camera 130, but does not cause or control the transmission of visual advertisements to the display 180 to be visually displayed.

In various embodiments, the testing controller 500 comprises a storage 560 storing at least a control routine 545, a processor circuit 550, and an interface 590. In some embodiments, the testing controller 500 further comprises and/or is communicatively coupled to a display 580 and an input device 520. Also, during operation of the testing controller 500, the storage 560 is caused to further store a camera data 543; along with test support data received from the input device 520 and stored as one or more of a detection data 542, an image data 541 and an impression data 540; and also along with an accuracy data 344.

In various embodiments, the testing controller 500 is initially employed in a test preparation phase to record a motion test video and test support data concerning images of faces appearing in the motion test video and the persons associated with those faces. The processor circuit 550 is caused by executing a sequence of instructions of the control routine 545 to receive and store frames of captured motion imagery from the camera 130 as the camera data 543. Alternatively, the processor circuit 550 may be caused to receive and store as the camera data 543 frames of captured motion imagery from another camera (not shown) that is positioned relative to the camera 130 so as to have a similar view and exposure to similar conditions as the camera 130, and to thereby capture imagery quite similar to what the camera 130 captures.

The processor circuit 550 is also caused to subsequently visually display the captured video frames of the camera data 543 on the display 580 to a test support person who views the video frames and operates the input device 520 to provide at least a portion of the test support data indicating the locations of regions within each video frame where an image of a face appears and/or statistics concerning the number of times a each face appears through the motion test video and for how long on each occasion. The test support data may also comprise indications of the age and/or gender of the persons associated with each face appearing on any of the frames. While the test support person may be tasked with looking at each face in the motion test video to discern such characteristics as age and/or gender from what they see, it may be deemed desirable to obtain such portions of the test support data from interviews with the persons who appear in the motion test view and/or from having those persons operate the input device 520 to directly provide the such portions of the test support data.

As the input device 520 is operated by at least the support person to provide the test support data, the processor circuit 550 is further caused to receive signals from the input device 520 conveying the input of the test support data, and is caused to store portion indications of detected images of faces as the detection data 542, indications of characteristics of the images of faces in each frame as the image data 541, and indications of determination of behavior of persons associated with those faces, such as impressions and dwell time, as the impression data 540. It should be noted, however, that despite the specific depiction and discussion of a particular organization of particular pieces of data within the storages 160 and 560, different embodiments may organize such data in any of a wide variety of ways, and this may depend on the video analysis algorithm(s) used by the video analytics system 100.

In various embodiments, the testing controller 500 is subsequently employed in a testing phase, making use of the test motion video and the test support data acquired during the test preparation phase to perform a test of the video analytics system 100. The processor circuit 550 is caused to transmit the motion test video stored as the camera data 543 to the video analytics system 100, where it is buffered within the storage 160 as the camera data 143 for the processor circuit 150 to be caused to analyze as previously described. The processor circuit 550 is then caused to receive the results of the analyses performed by the video analytics system 100 as the video analytics system 100 transmits the results as output data comprising one or more of the detection data 142, the image data 141 and the impression data 140 to the testing controller 500.

It should be noted that the particular depiction of the manner in which the camera data 543, the detection data 142, the image data 141, the impression data 140 and the accuracy data 344 are depicted as being exchanged between the video analytics system 100 and the testing controller 500 in FIG. 1 is a conceptual depiction. More specifically, in various embodiments, the processor circuits 150 and 550 are caused to operate the interfaces 190 and 590, respectively, to effect exchanges of signals between the video analytics system 100 and the testing controller 500 by which these transfers of data are performed.

More particularly, it may be that for purposes of testing, the camera 130 may in some manner be uncoupled from one or more components of the video analytics system 100 and coupled to the test controller 200 for the receipt of the output of the camera 130 by the test controller 200. However, it may also be that the camera 130 remains coupled to the video analytics system 100 in whatever way is desired for normal operation of the video analytics system 100, and the output of the camera 130 is relayed to the test controller 200 by way of the processor 150 operating the interface 190 to transmit it and the processor 550 operating the interface 590 to received it. As will be explained in greater detail, the signaling employed by each of the interfaces 190 and 590 may be based on any of a variety of signaling technologies supporting any of a variety of cabling-based or wireless communications technologies.

Regardless of the exact manner in which one or more of the detection data 142, the image data 141 and the impression data 140 are received from the video analytics system 100, the processor circuit 550 is caused to perform a number of comparisons between this data received from the video analytics system 100 and the test support data stored as corresponding ones of the detection data 542, the image data 541 and the impression data 540. In performing these comparisons, the processor circuit 550 is caused to generate the accuracy data 344.

In various embodiments, each of the processor circuits 150 and 550 may comprise any of a wide variety of commercially available processors, including without limitation, an AMD® Athlon®, Duron® or Opteron® processor; an ARM® application, embedded and secure processors; an IBM® and/or Motorola® DragonBall® or PowerPC® processor; an IBM and/or Sony® Cell processor; or an Intel® Celeron®, Core (2) Duo®, Core (2) Quad®, Core i3®, Core i5®, Core i7®, Atom®, Itanium®, Pentium®, Xeon® or XScale® processor. Further, one or more of these processor circuits may comprise a multi-core processor (whether the multiple cores coexist on the same or separate dies), and/or a multi-processor architecture of some other variety by which multiple physically separate processors are in some way linked.

In various embodiments, each of the storages 160 and 560 may be based on any of wide variety of information storage technologies, possibly including volatile technologies requiring the uninterrupted provision of electric power, and possibly including technologies entailing the use of machine-readable storage media that may be removable, or that may not be removable. Thus, each of these storages may comprise any of a wide variety of types of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of the storages 160 and 560 are depicted as a single block, one or more of these may comprise multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM).

In various embodiments, each of the routines 145 and 545 may comprise an operating system that may be any of a variety of available operating systems appropriate for whatever corresponding ones of the processor circuits 150 and 550 comprise, including without limitation, Windows™, OS X™, Linux®, or Android OS™. Further, the analytics routine may be based on any of a variety of algorithms for detecting, analyzing and determining various characteristics of faces present in the frames of motion video.

In various embodiments, each of the interfaces 190 and 590 may employ any of a wide variety of signaling technologies enabling each of devices 100 and 500 to be communicatively coupled to other devices, including other computing devices. Each of these interfaces comprises circuitry providing at least some of the requisite functionality to enable access to other devices, either via direct coupling or through one or more networks (e.g., the network 1000). However, each of these interfaces may also be at least partially implemented with sequences of instructions executed by corresponding ones of the processor circuits 150 and 550 (e.g., to implement a protocol stack or other features). Where electrically and/or optically conductive cabling is employed in coupling to other devices, corresponding ones of the interfaces 190 and 590 may employ signaling and/or protocols conforming to any of a variety of industry standards, including without limitation, RS-232C, RS-422, USB, Ethernet (IEEE-802.3) or IEEE-1394. Alternatively or additionally, where wireless signal transmission is employed in coupling to other devices, corresponding ones of the interfaces 190 and 590 may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1 xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc. It should be noted that although each of the interfaces 190 and 590 are depicted as a single block, one or more of these may comprise multiple interfaces that may be based on differing signaling technologies.

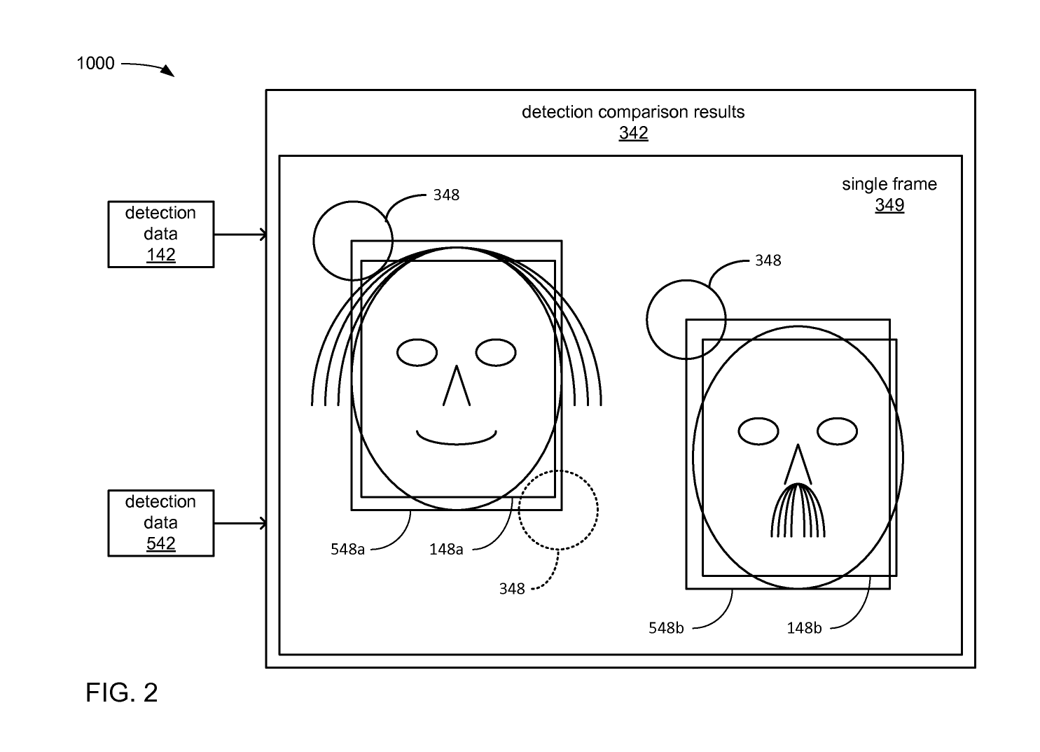

FIG. 2 illustrates a block diagram that is partially a subset of the block diagram of FIG. 1 and that also depicts details of some of the comparisons performed by the processor circuit 550. Specifically, aspects of comparisons made between the detection data 142 received from the video analytics system 100 and the detection data 542 originally received via the input device 520 (as part of the test support data) are graphically depicted. Although the testing controller 500 is operable to test variants of the video analytics system 100 that may be based on any of a variety of video analysis algorithms, in various embodiments, at least some of the comparisons performed by the processor circuit 550 are based on a presumption that the algorithm(s) employed by the video analytics system 100 initially identify rectangular regions of pixels within each video frame that depict a face in preparation for analyzing those rectangular regions of pixels to discern more concerning those faces.

As depicted in a graphical representation of an example single frame 349 of the motion test video stored as the camera data 543, the video analytics system 100 and the test support person viewing the motion test video on the display 580 have each identified two rectangular regions of pixels within the single frame 349 as comprising an image of a face. More specifically, the detection data 142 received from the video analytics system 100 identifies each of rectangular regions 148a and 148b as comprising an image of a face, and the detection data 542 received as part of the test support data entered via the input device 520 identifies each of rectangular regions 548a and 548b as comprising an image of a face.

In preparation for the processor circuit 550 making comparisons between the detection data 142 and the detection data 542, the rectangular regions indicated for each video frame in the detection data 142 must first be matched to the rectangular regions indicated in the detection data 542. More precisely, rectangular regions indicated in the detection data 142 and the detection data 542 that are associated with the same image of a particular face in a particular video frame must be matched. While ideally, the locations and sizes of such regions identified by the video analytics system 100 and the test support person for each video frame would match exactly down to the last pixel, as depicted in the example single frame 349, this is often not the case.

Thus, for each video frame, each of the rectangular regions indicated in the detection data 142 are compared to each of the rectangular regions indicated in the detection data 542 to identify rectangular regions of the detection data 142 and the detection data 542 that sufficiently overlap to be deemed to be a match, and thus, deemed to be associated with the same image of a face on that video frame. The processor circuit 550 is caused to determine the sufficiency of overlap between a rectangular region of the detection data 142 and a rectangular region of the detection data 542 by comparing the radial distance from a chosen corner of each to a threshold radial distance. The threshold radial distance is selected to be large enough to permit an expected degree of difference in the manner in which the video analytics system 100 and the test support person specify the boundaries of a rectangular region of pixels comprising an image of a face, but not so large that rectangular regions associated with different faces might errantly be deemed a match.

As depicted in the example single frame 349, upper left-hand corners of the rectangular regions 148a-b and 548a-b are selected for measuring radial distances between rectangular regions, with the threshold radial distance 348 from the upper left-hand corners of each of the rectangular regions 548a and 548b being graphically depicted in FIG. 2. Given that the locations and sizes of each of the rectangular regions 148a-b and 548a-b are measured in pixel, the radial distance and its threshold 348 are also measured in pixels. As can be seen, the upper left-hand corners of the rectangular regions 148a and 148b are within the threshold radial distance 348 of the upper left-hand corners of the rectangular regions 548a and 548b, respectively, such that the rectangular regions 148a and 548a are deemed to be one match associated with an image of one face and the rectangular regions 148b and 548b are deemed to be another match associated with an image of another face.

In some embodiments, a second radial distance may be measured from a second diagonally opposite chosen corner may be used with the same threshold radial distance to further confirm a match between two rectangular regions, this being depicted in FIG. 2 for the rectangular regions 148a and 548a with dotted lines. This may be done to ensure that one of the rectangular regions 148a or 548a is not so much larger or smaller than the other of these two rectangular regions that they could not possible both be associated with the same image of a face. As those skilled in the analysis of faces in a crowd will recognize, it is possible to have the image of the face of one person partially overlap the image of the face of another as a result of one person's head being positioned in front of the other in the field of view of a camera. In such a situation, it is possible that a rectangular region associated with the image of one of such faces would have a corner quite close to another and would partially overlap the other, but the diagonally opposite corners of the two rectangular regions would be measurably further apart.

Upon completing the matching of rectangular regions indicated in the detection data 142 and the detection data 542 for each video frame, the processor circuit 550 is further caused to identify rectangular regions of either data that have not been matched to determine whether the video analytics system 100 successfully identified all of the faces that are present in each video frame of the motion test video and did not falsely identifying a face in a video frame where none exists. An assumption is made that the test support person will be perfectly correct in their identification of rectangular regions of pixels comprising images of faces such that the indications of rectangular regions comprising an image of a face in the detection data 542 is deemed accurate. Thus, a “false negative” exists where the video analytics system 100 has failed to locate an image of a face on a video frame is deemed to have occurred where the detection data 542 indicates the location of such a rectangular region on a video frame and the detection data 142 provided by the video analytics system 100 does not. And correspondingly, a “false positive” exists where the video analytics system 100 has indicated the location of an image of a face in a frame that is not actually there is deemed to have occurred in instances where the detection data 142 provided by the video analytics system 100 indicates the location of such a rectangular region on a video frame and the detection data 542 does not.

Upon identifying any instances of false negatives or false positives due to there being unmatched rectangular regions, the processor 550 is further caused to derive metrics indicating the degree of accuracy of the video analytics system in identifying faces throughout the frames of the motion test video, and store those metrics as part of the accuracy data 344. In various embodiments, such metrics comprise a rate of false negatives, FNE (false negative error), calculated as . . .

$$F N E = \frac{{\sum }_{n = 1}^{N} F n}{N}$$

. . . and a rate of false positives, FPE (false positive error), calculated as . . .

$$F P E = \frac{{\sum }_{n = 1}^{N} P n}{N}$$

. . . where N is the total number of video frames of the motion test video, Fn is the number of false negatives occurring in the n-th video frame, and Pn is the number of false positives occurring in the nth frame. Thus, FNE is the sum of all false negatives occurring across all of the frames, divided by the total number of frames, and FPE is the sum of all false positives occurring across all of the video frames divided by the total number of video frames. The range of values for FNE and FPE is 0 to 1, with a value of 0 for both FNE and FPE indicating a perfect performance by the video analytics system 100 in identifying the presence of images of faces throughout the motion test video.

In various embodiments, the processor circuit 550 is caused to compare the locations of the centers of matched ones of the rectangular regions indicated in the detection data 542 and the detection data 142 to derive a metric indicating the degree of accuracy of the video analytics system 100 in tracking, which the processor circuit 550 is further caused to store as part of the accuracy data 344. In so doing, only matched rectangular regions are employed, and any unmatched rectangular regions are ignored. For each matched pair of rectangular regions, the Euclidean distance between the locations of the centers of each of the two rectangular regions is measured in pixels. Then a tracking match error (TME) is calculated as . . .

$$T M E = \frac{{\sum }_{n = 1}^{N} {\sum }_{i = 1}^{On} Dni}{{\sum }_{n = 1}^{N} On}$$

. . . where N is the total number of video frames of the motion test video, On is the total number of matched pairs of rectangular regions in the n-th video frame, and Dni is the Euclidean distance measured between the centers of each of the two rectangular regions in the i-th matched pair of rectangular regions of the n-th video frame. Thus, TME is the sum of all Euclidean distances measured in pixels between the centers of each of the rectangular regions of each matched pair of rectangular regions occurring across all of the video frames, divided by total number of matched pairs of rectangular regions occurring across all of the video frames. The range of values for TME is 0 to the Euclidean distance measured in pixels between diagonally opposed corners of a video frame, with a value of 0 indicating perfect tracking by the video analytics system 100.

In various embodiments, the processor circuit 500 is caused to compare indications of age of each person associated with an image of a face in the image data 541 to such indications in the image data 141 to derive a metric indicating the degree of accuracy of the video analytics system 100 in determining age based on an image of a face, which the processor 550 is further caused to store as part of the accuracy data 344. In so doing, only indications of age associated with images of faces associated with matched pairs of rectangular regions are employed. In some embodiments, age is specified in the image data 141 and 541 in ranges of years of age, rather than precise years of age. A specific range of years of age may be selected to distinguish persons within a particular range of ages of interest (e.g., teenagers, senior citizens, middle-aged adults, etc.) for being targeted with advertising in a particular marketing effort from persons outside that particular range of ages. Alternatively or additionally, one or more specific ranges of years of age may be selected based on studies indicating that one or more of those specific ranges is statistically detectable with relatively higher reliability. Regardless of the exact manner in which ranges of age are selected, for each matched pair of rectangular regions, or whether ages are specified in ranges or not, indications of age in the image data 141 and 541 are compared to determine whether they match. Then an age match error (AME) is calculated as . . .

$$A M E = \frac{{\sum }_{n = 1}^{N} {\sum }_{i = 1}^{On} Ani}{{\sum }_{n = 1}^{N} On}$$

. . . where N is the total number of video frames of the motion test video, On is the total number of matched pairs of rectangular regions in the n-th video frame, and Ani is assigned a value dependant on whether the indications of age in the image data 141 and the image data 541 match for the i-th matched pair of rectangular regions of the n-th video frame. In some embodiments, the value assigned to Ani is 0 where there is a match in the indications of age, and is 1 where there indications of age differ. Thus, AME is the sum of all the values assigned to Ani for each matched pair of rectangular regions occurring across all of the video frames, divided by total number of matched pairs of rectangular regions occurring across all of the video frames. The range of values for AME is 0 to 1, with a value of 0 for AME indicating a perfect performance by the video analytics system 100 in determining the age of the persons associated with images of faces throughout the motion test video.

In various embodiments, the processor circuit 500 is caused to compare indications of gender of each person associated with an image of a face in the image data 541 to such indications in the image data 141 to derive a metric indicating the degree of accuracy of the video analytics system 100 in determining gender based on an image of a face, which the processor 550 is further caused to store as part of the accuracy data 344. In so doing, only indications of gender associated with images of faces associated with matched pairs of rectangular regions are employed. For each matched pair of rectangular regions, indications of gender in the image data 141 and 541 are compared to determine whether they match. Then a gender match error (GME) is calculated as . . .

$$G M E = \frac{{\sum }_{n = 1}^{N} {\sum }_{i = 1}^{On} Gni}{{\sum }_{n = 1}^{N} On}$$

. . . where N is the total number of video frames of the motion test video, On is the total number of matched pairs of rectangular regions in the n-th video frame, and Gni is assigned a value dependant on whether the indications of gender in the image data 141 and the image data 541 match for the i-th matched pair of rectangular regions of the n-th video frame. In some embodiments, the value assigned to Gni is 0 where there is a match in the indications of gender, and is 1 where there indications of gender differ. Thus, GME is the sum of all the values assigned to Gni for each matched pair of rectangular regions occurring across all of the video frames, divided by total number of matched pairs of rectangular regions occurring across all of the video frames. The range of values for GME is 0 to 1, with a value of 0 for GME indicating a perfect performance by the video analytics system 100 in determining the gender of the persons associated with images of faces throughout the motion test video.

The creation of metrics representing the sum of errors across multiple video frames for false negatives, false positives, tracking, age determination and gender determination is advantageous over the past practice of providing metrics for each of these possible forms of error for only a single video frame. Earlier generations of video analytics systems that treated each video frame of a portion of motion video as a discrete entity (essentially akin to a still photo), making no use of any preceding or subsequent video frames to recognize the presence of an image of a face or to determine characteristics of the person associated with that face. In contrast, newer generations of video analytics systems analyze each video frame in a manner informed by the content of the video frames preceding and following it to clarify ambiguities in what is depicted in each video frame to more accurately distinguish an image of a face from images of other objects that may appear somewhat misleadingly like faces.

Such use of multiple video frames in conjunction, rather than in isolation, to distinguish faces from other objects is in recognition of the manner in which the brain makes use of the passage of time, and thus, the brain's equivalent to multiple video frames, in recognizing the sight of a face in situations in which seeing the face may be difficult. By way of example, the brain takes head movement into account in distinguishing a face from other objects or an optical illusion that may seem, only in a glance, to look like a face. If an object that looks, at a glance, like it could be a face moves in a manner that seems unlikely or unnatural as head movement, then the brain tends to discount the possibility that the object could be a face. By way of another example where a face of a moving person is partially obscured by an object or interplay of light and shadow, the person's movement may cause their face to move such that different portions of their face are obscured over a brief period of time. The braids short term memory retains the images of the unobscured portions seen over that brief period of time, and assembles those unobscured portions from short term memory to recognize that face as a face.

Further, newer generations of video analytics systems also employ the information of multiple frames in determining characteristics of persons associated with detected faces, such as age and gender. And again, this is in recognition of the frequent use by the brain of a changing view of a person's face (e.g., as that person turns their head) in determining that person's age or gender, since a changing view often reveal different details of that person's face at different moments that the brain is able to combine in its analysis.

With newer video analytics techniques moving towards the use of aspects of multiple video frames in analyzing motion video to recognize faces and characteristics of people associated with faces, the longstanding practice of rating accuracy on a per-frame basis, such as a rate of false negatives or false positives in only a single frame, can provide a misleading picture of accuracy.

In various embodiments, the processor circuit 550 is caused to calculate a rating of accuracy of the impression count determined by the video analytics system 100. As is known to those skilled in the art, a single “impression” in the area of video analytics involving motion video is the occurrence of a face of a person becoming visible in the field of view of a camera, and lasts through any number of video frames until that person either turns away or moves outside the field of view such that their face is no longer visible. If the face of that same person subsequently becomes visible again that field of view, it is considered to be a new impression. In being tested with the motion test video, the processor circuit 150 of the video analytics system 100 is caused to determine how many impressions have occurred across all of the video frames of the motion test video, that number being an impression count It, which the processor 150 is caused to store as part of the impression data 140. During the test preparation phase, the test support person also makes a determination of how many impressions have occurred across all of the video frames of the motion test video, that number being an impression count Is. The processor circuit 550 receives the signals from the input device 520 indicating the impression count provided by the test support person and stores it as part of the impression data 540. The impression count error (ICE) is calculated as . . .

$$I C E = \frac{It - Is}{Is}$$

Thus, ICE is the impression count determined by the video analytics system 100 subtracted by the impression count determined by the test support person, the resulting number of that subtraction then divided by the impression count determined by the test support person. The range of values for ICE is −1 to 1. A negative value indicates undercounting by the video analytics system 100, a positive value indicates overcounting by the video analytics system 100, and a value of 0 indicates perfect performance by the video analytics system 100 in determining the impression count. The processor circuit 550 then stores the resulting value for ICE as part of the accuracy results 344.

In various embodiments, the processor circuit 550 is caused to calculate a rating of accuracy in the measuring of an average dwell time by the video analytics system 100. As is known to those skilled in the art, a “dwell time” is the amount of time an impression lasts. In being tested with the motion test video, the processor circuit 150 of the video analytics system 100 is caused to determine the dwell time for each impression that the processor circuit 150 determines has occurred. The processor circuit 150 is then caused to calculate the average of all of the dwell times of all of the impressions that have occurred across all of the video frames of the motion test video, that number being an average dwell time DTt, which the processor 150 is caused to store as part of the impression data 140. During the test preparation phase, the test support person also determines the dwell times for each impression, and then provides the average of all of those dwell times, that number being an average dwell time DTs. The processor circuit 550 receives the signals from the input device 520 indicating the average dwell time provided by the test support person and stores it as part of the impression data 540. The dwell time error (DTE) is calculated as . . .

$$D T E = \frac{\vert DTt - DTs \vert}{DTs}$$

Thus, DTE is the absolute value of the difference between the average dwell time determined by the video analytics system 100 and the average dwell time determined by the test support person, divided by the average dwell time determined by the test support person. The range of values for DTE is 0 to 1, with a value of 0 for DTE indicating perfect performance by the video analytics system 100 in determining the average dwell time. The processor circuit 550 then stores the resulting value for DTE as part of the accuracy results 344.

Following the testing mode, with the values for the above and/or other error metrics having been determined and stored as the accuracy data 344, the processor circuit 550 may be further caused by the control program 545 to visually display the results on the display 580. Alternatively or additionally, where the analytics algorithms employed by the video analytics system 100 is at least partly adaptive, the processor circuit 550 may be further caused to operate the interface 590 to transmit the accuracy data 344 to the analytics system 100. The processor circuit 150 is caused by the analytics routine 145 to operate the interface 190 to receive the accuracy data 344 and store it in the storage 160, and subsequently, to adjust one or more setting employed in analyzing video in response to the error metrics of the accuracy data 344.

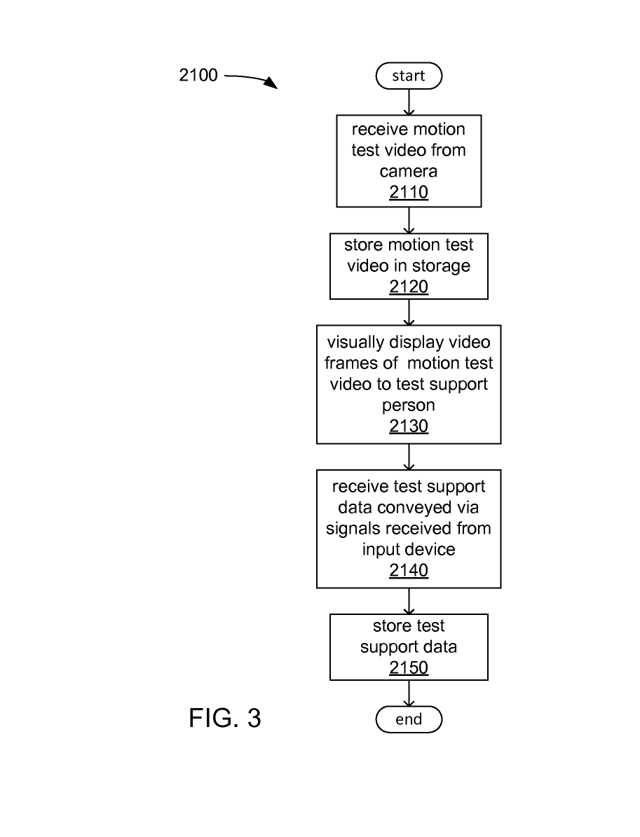

FIG. 3 illustrates one embodiment of a logic flow 2100. The logic flow 2100 may be representative of some or all of the operations executed by one or more embodiments described herein. More specifically, the logic flow 2100 may illustrate operations performed by the processor circuit 550 of the testing controller 500 in executing the control routine 545.

At 2110, a testing controller (e.g., the controller 500) receives a motion test video from a camera. As previously discussed, this may be the camera of a video analytics system to be tested with the testing controller (e.g., the camera 130 of the video analytics system 100), or this may be a separate camera positioned in a manner that is co-located with the camera of the video analytics system to be tested so as to have a similar field of view under similar conditions so that the motion test video will more qualitatively reflect what that video analytics system receives from its own camera.

At 2120, the motion test video is stored within a storage of the testing controller (e.g., the storage 560) in preparation for use in testing. Video frames of the motion test video are visually displayed by the testing controller on a display (e.g., the display 580) to a test support person at 2130.

At 2140, an input device of the testing controller (e.g., the input device 520) is operated by the test support person to signal the testing controller with indications of various pieces of test support data, including indications of locations and size (in pixels) of rectangular regions of each video frame comprising an image of a face, indications of age and/or gender of the persons associated with the faces that appear in the motion test video, an impression count and dwell times for each of the impressions.

At 2150, the test support data received via the input device are stored in preparation for use in testing.

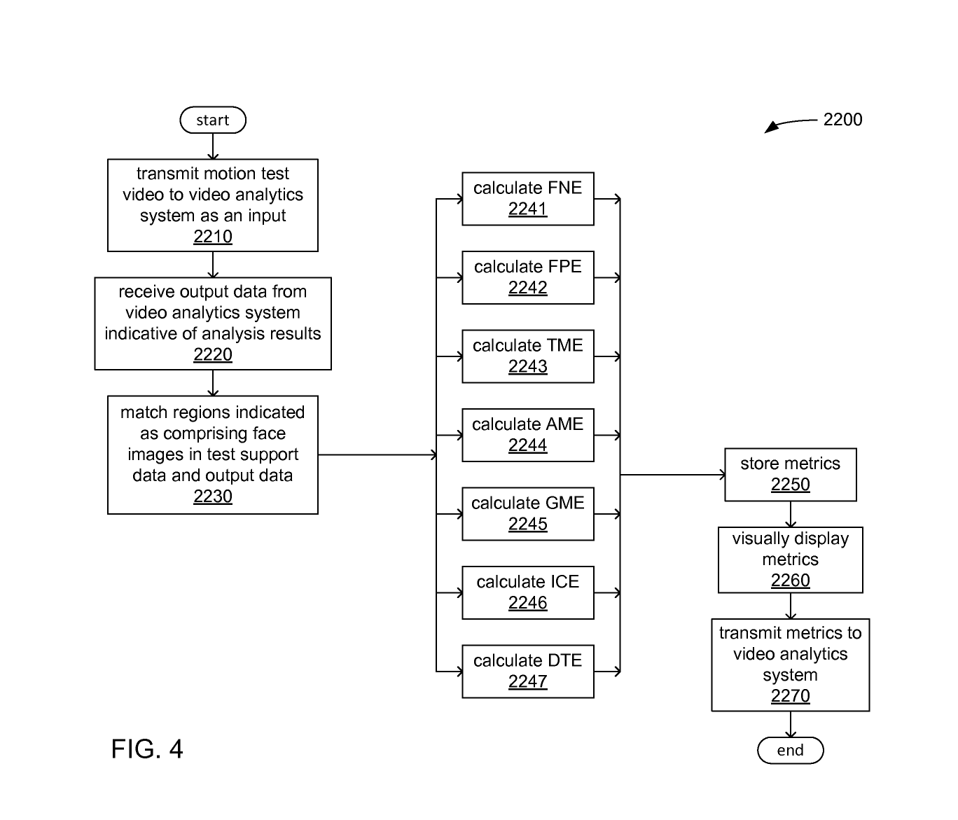

FIG. 4 illustrates one embodiment of a logic flow 2200. The logic flow 2200 may be representative of some or all of the operations executed by one or more embodiments described herein. More specifically, the logic flow 2200 may illustrate operations performed by the processor circuit 550 of the testing controller 500 in executing the control routine 545.

At 2210, a testing controller (e.g., the testing controller 500) transmits a motion test video to a video analytics system (e.g., the video analytics system 100) as an input for video analysis in place of video that the video analytics system would normally receive from a camera associated with it (e.g., the camera 130).

At 2220, the testing controller receives output data from the video analytics system conveying results of its analysis of the motion test video.

At 2230, the testing controller compares indications of rectangular regions as comprising images of faces from the test support data to the output data, and matches rectangular regions of one to rectangular regions of the other, forming matched pairs of rectangular regions where the two rectangular regions in each such pair is deemed to be associated with the same image of a face.

At 2241 through 2247, the testing controller calculates various metrics, specifically, a false negative error (FNE), a false positive error (FPE), a track match error (TME), an age match error (AME), a gender match error (GME), an impression count error (ICE) and a dwell time error (DTE). Although these calculations at 2241-2247 are depicted in a manner suggesting they are made substantially simultaneously, they may be made sequentially and in any conceivable order.

At 2250, the testing controller stores these metrics in a storage (e.g., the storage 560) as portions of an accuracy data, and may visually display these metrics on a display (e.g., the display 580) at 2260. At 2270, the testing controller may transmit at least a portion of the accuracy data to the video analytics system, enabling the video analytics system to employ them as an input where the video analytics system implements an adaptive form of video analysis.

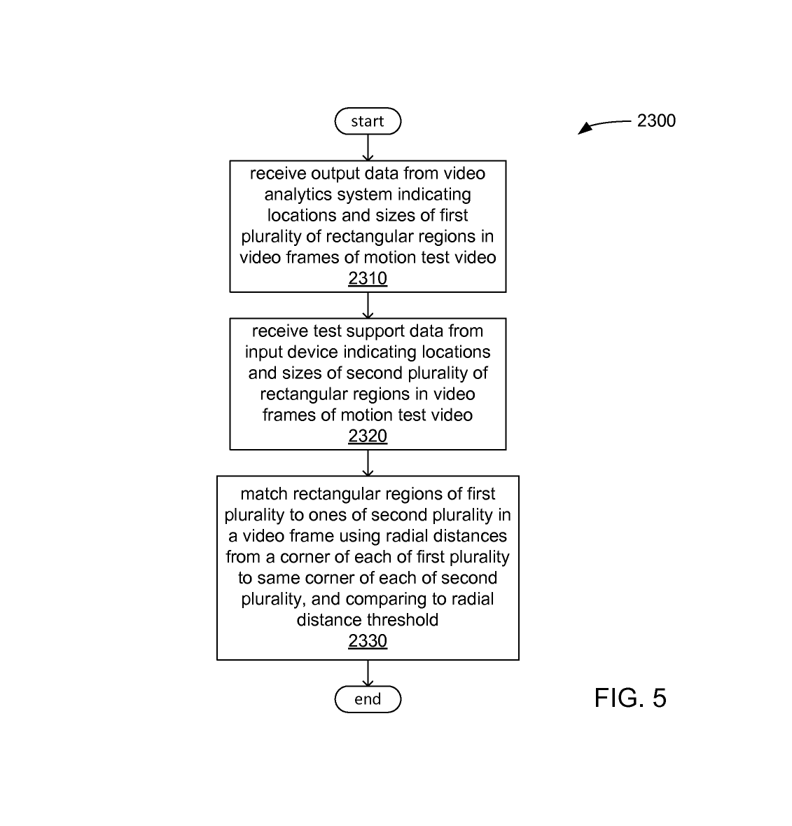

FIG. 5 illustrates one embodiment of a logic flow 2300. The logic flow 2300 may be representative of some or all of the operations executed by one or more embodiments described herein. More specifically, the logic flow 2300 may illustrate operations performed by the processor circuit 550 of the testing controller 500 in executing the control routine 545.

At 2310, at least one component of a computing device (e.g., the processor circuit 550 of the testing controller 500) receives a first signal from a first other device (e.g., the video analytics system 100) indicating locations and sizes of a first plurality of rectangular regions indicated as comprising images of faces in the video frames of a motion test video.

At 2320, the same at least one component of the computing device receives a second signal from a second other device (e.g., the input device 520) indicating locations and sizes of a second plurality of rectangular regions indicated as comprising images of faces in the video frames of the same motion test video.

At 2330, the same at least one component of the computing device matches rectangular regions of the first plurality of rectangular regions in a video frame to rectangular regions of the second plurality of rectangular regions in the same video frame by measuring radial distances from a particular corner of each one of the rectangular regions of the first plurality in that video frame to the same corner of each one of the rectangular regions of the second plurality in that video frame, and comparing those radial distances to a radial distance threshold.

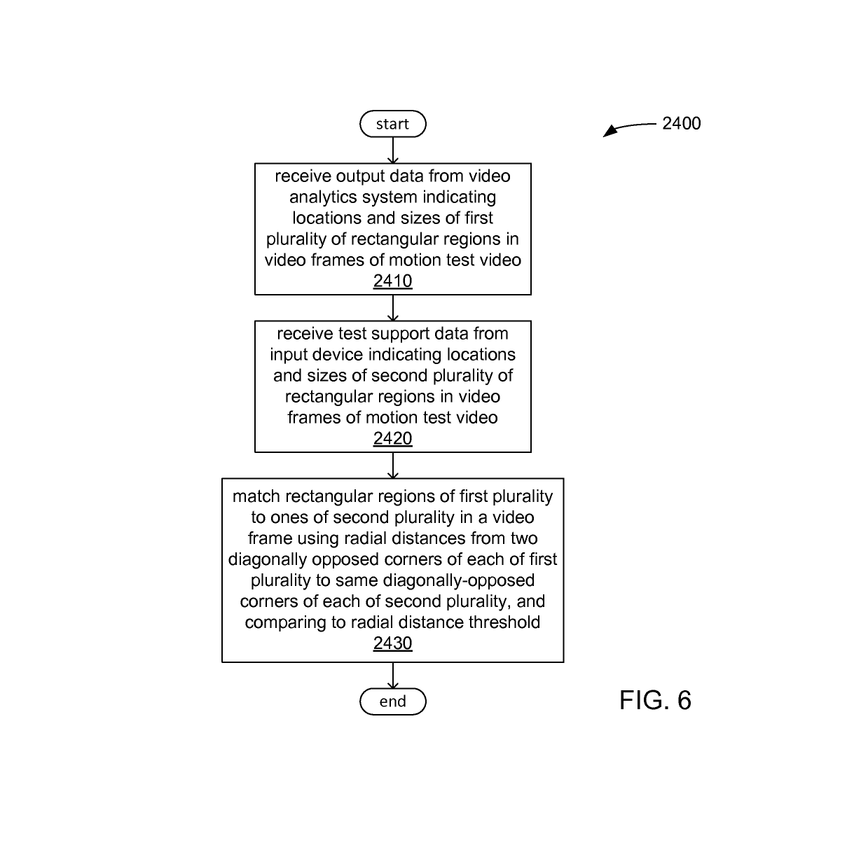

FIG. 6 illustrates one embodiment of a logic flow 2400. The logic flow 2400 may be representative of some or all of the operations executed by one or more embodiments described herein. More specifically, the logic flow 2400 may illustrate operations performed by the processor circuit 550 of the testing controller 500 in executing the control routine 545.

At 2410, at least one component of a computing device (e.g., the processor circuit 550 of the testing controller 500) receives a first signal from a first other device (e.g., the video analytics system 100) indicating locations and sizes of a first plurality of rectangular regions indicated as comprising images of faces in the video frames of a motion test video.

At 2420, the same at least one component of the computing device receives a second signal from a second other device (e.g., the input device 520) indicating locations and sizes of a second plurality of rectangular regions indicated as comprising images of faces in the video frames of the same motion test video.

At 2430, the same at least one component of the computing device matches rectangular regions of the first plurality of rectangular regions in a video frame to rectangular regions of the second plurality of rectangular regions in the same video frame by measuring radial distances from two diagonally-opposed corners of each one of the rectangular regions of the first plurality in that video frame to the same diagonally-opposed corners of each one of the rectangular regions of the second plurality in that video frame, and comparing those radial distances to a radial distance threshold.

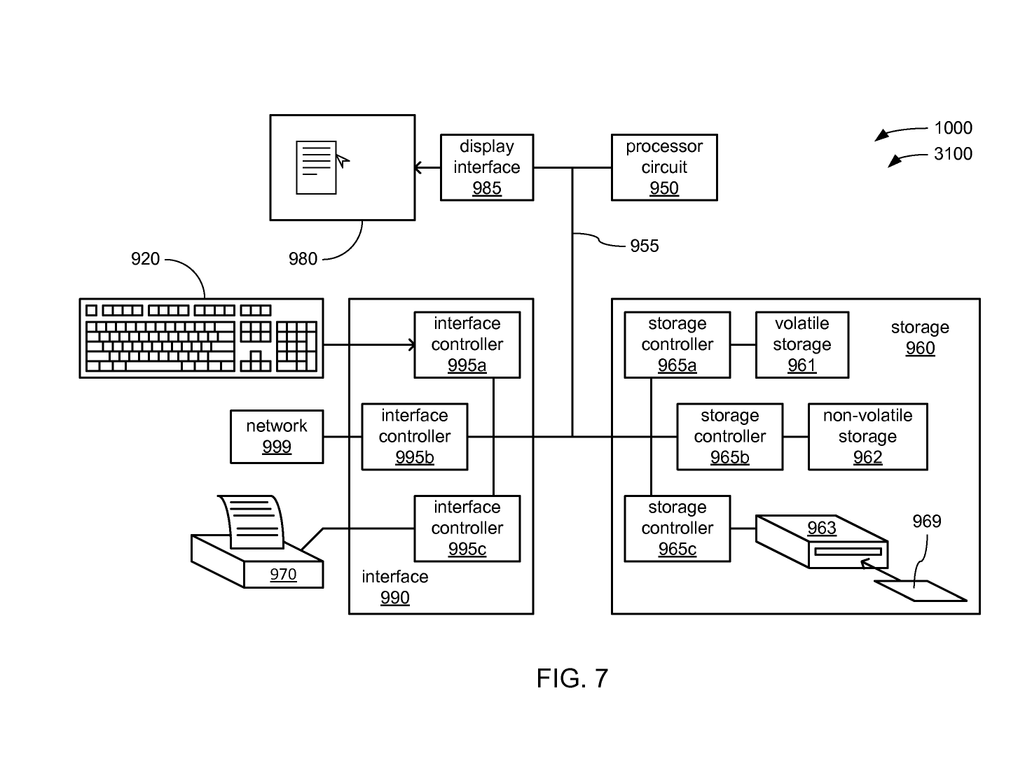

FIG. 7 illustrates an embodiment of an exemplary processing architecture 3100 suitable for implementing various embodiments as previously described. More specifically, the processing architecture 3100 (or variants thereof) may be implemented as part of one or more of the computing devices 100 and 500. It should be noted that components of the processing architecture 3100 are given reference numbers in which the last two digits correspond to the last two digits of reference numbers of components earlier depicted and described as part of each of the computing devices 100 and 500. This is done as an aid to correlating such components of whichever ones of the computing devices 100 and 500 may employ this exemplary processing architecture in various embodiments.

The processing architecture 3100 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor circuit, the processor circuit itself, a storage device (e.g., a hard disk drive, multiple storage drives in an array, etc.) that may employ an optical and/or magnetic storage medium, a software object, an executable sequence of instructions, a thread of execution, a program, and/or an entire computing device (e.g., an entire computer). For example, both an application running on a server and the server itself can be components. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For example, the components may communicate information in the form of signals communicated over the communications media. The information can be implemented as signals allocated to one or more signal lines. Each message may be a signal or a plurality of signals transmitted either serially or substantially in parallel.

As depicted, in implementing the processing architecture 3100, a computing device comprises at least a processor circuit 950, a storage 960, an interface 990 to other devices, and coupling 955. As will be explained, depending on various aspects of a computing device implementing the processing architecture 3100, including its intended use and/or conditions of use, such a computing device may further comprise additional components, such as without limitation, a display interface 985.

Coupling 955 is comprised of one or more buses, transceivers, buffers, crosspoint switches, and/or other conductors and/or logic that communicatively couples at least the processor circuit 950 to the storage 960. Coupling 955 may further couple the processor circuit 950 to one or more of the interface 990 and the display interface 985 (depending on which of these and/or other components are also present). With the processor circuit 950 being so coupled by couplings 955, the processor circuit 950 is able to perform the various ones of the tasks described at length, above, for whichever ones of the computing devices 100, 300 and 500a-d implement the processing architecture 3100. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor circuit 950 (corresponding to one or more of the processor circuits 150 and 550) may comprise any of a wide variety of commercially available processors, employing any of a wide variety of technologies and implemented with one or more cores physically combined in any of a number of ways.

As previously discussed, the storage 960 (corresponding to one or more of the storages 160 and 560) may comprise one or more distinct storage devices based on any of a wide variety of technologies or combinations of technologies. More specifically, as depicted, the storage 960 may comprise one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly comprising multiple distinct types of storage is in recognition of the commonplace use of more than one type of storage device in computing devices in which one type provides relatively rapid reading and writing capabilities enabling more rapid manipulation of data by the processor circuit 950 (but possibly using a “volatile” technology constantly requiring electric power) while another type provides a relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and comprises one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and comprises one or more optical and/or solid-state disk drives employing one or more pieces of machine-readable storage media 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage media 969.

One or the other of the volatile storage 961 or the non-volatile storage 962 may comprise an article of manufacture in the form of a machine-readable storage media on which a routine comprising a sequence of instructions executable by the processor circuit 960 may be stored, depending on the technologies on which each is based. By way of example, where the non-volatile storage 962 comprises ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to removable storage media such as a floppy diskette. By way of another example, the non-volatile storage 962 may comprise banks of solid-state storage devices to store information, such as sequences of instructions, in a manner akin to a compact flash card. Again, it is commonplace to employ differing types of storage devices in a computing device at different times to store executable routines and/or data. Thus, a routine comprising a sequence of instructions to be executed by the processor circuit 960 may initially be stored on the machine-readable storage media 969, and the removable media storage 963 may be subsequently employed in copying that routine to the non-volatile storage 962 for longer term storage not requiring the continuing presence of the machine-readable storage media 969 and/or the volatile storage 961 to enable more rapid access by the processor circuit 960 as that routine is executed.

As previously discussed, the interface 990 (corresponding to one or more of the interfaces 190 and 590) may employ any of a variety of signaling technologies corresponding to any of a variety of communications technologies that may be employed to communicatively couple a computing device to one or more other devices. Again, one or both of various forms of wired or wireless signaling may be employed to enable the processor circuit 950 to interact with input/output devices (e.g., the depicted example keyboard 920 or printer 970) and/or other computing devices, possibly through a network (e.g., the network 999) or an interconnected set of networks. In recognition of the often greatly different character of multiple types of signaling and/or protocols that must often be supported by any one computing device, the interface 990 is depicted as comprising multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999. The interface 995c may employ any of a variety of electrically conductive cabling enabling the use of either serial or parallel signal transmission to convey data to the depicted printer 970. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, laser printers, inkjet printers, mechanical robots, milling machines, etc.

Where a computing device is communicatively coupled to (or perhaps, actually comprises) a display (e.g., the depicted example display 980, corresponding to one or both of the displays 180 and 580), such a computing device implementing the processing architecture 3100 may also comprise the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

More generally, the various elements of the computing devices 100, 300 and 500a-d may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed processing architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

An example computer-implemented method comprising: receiving a first signal from a first device conveying a first data specifying boundaries of a first rectangular region indicated as comprising an image of a face in a video frame of a motion video; receiving a second signal from a second device conveying a second data specifying boundaries of a second rectangular region indicated as comprising an image of a face in the video frame of the motion video; measuring a first distance between first corresponding corners of the first and second rectangular regions; comparing the first distance to a distance threshold; and determining whether the first and second rectangular regions comprise images of a same face based on the comparison.

The above example computer-implemented method, comprising: measuring a second distance between second corresponding corners of the first and second rectangular regions; comparing the second distance to the distance threshold; and determining whether the first and second rectangular regions comprise images of a same face based on the comparisons of the first and second distances to the distance threshold.

Either of the above-examples of computer-implemented method, comprising transmitting the motion video to the first device, the first data specifying boundaries of a first multitude of rectangular regions indicated as comprising images of faces in the motion video, the first multitude of rectangular regions comprising the first rectangular region.

Any of the above examples of computer-implemented method, comprising visually presenting video frames of the motion video on a display, the second device comprising an input device operable by a test support person viewing the video frames visually presented on the display, the second data specifying boundaries of a second multitude of rectangular regions indicated as comprising images of faces in the motion video, the second multitude of rectangular regions comprising the second rectangular region.

Any of the above examples of computer-implemented method, comprising: matching rectangular regions of the first multitude of rectangular regions to rectangular regions of the second multitude of rectangular regions; counting a number of rectangular regions of the first multitude of rectangular regions that cannot be matched to a rectangular region of the second multitude of rectangular regions; counting a number of rectangular regions of the second multitude of rectangular regions that cannot be matched to a rectangular region of the first multitude of rectangular regions; calculating a false positive error of the first device from the number counted of rectangular regions of the first multitude of rectangular regions that cannot be matched to a rectangular region of the second multitude of rectangular regions; and calculating a false negative error of the first device from the number counted of rectangular regions of the second multitude of rectangular regions that cannot be matched to a rectangular region of the first multitude of rectangular regions.

Any of the above examples of computer-implemented method, comprising measuring a track distance from the center of each matched rectangular region of the first multitude of rectangular regions to the center of each matching rectangular region of the second multitude of rectangular regions; and calculating a track match error of the first device from a total of all of the tracking distances divided by the number of matches of rectangular regions.

Any of the above examples of computer-implemented method, the first data specifying ages associated with each of the rectangular regions of the first multitude of rectangular regions, the second data specifying ages associated with each of the rectangular regions of the second multitude of rectangular regions, the method comprising: for each match of a rectangular region of the first multitude of rectangular regions to a rectangular region of the second multitude of rectangular regions, comparing an age associated with the matched rectangular region of the first multitude of rectangular regions to an age associated with the matched rectangular region of the second multitude of rectangular regions; counting the number of matches of rectangular regions from the first and second multitudes of rectangular regions in which the associated ages differ; and calculating an age match error from the number counted of matches in which the associated ages differ divided by the number of matches of rectangular regions.

Any of the above examples of computer-implemented method, the first data specifying genders associated with each of the rectangular regions of the first multitude of rectangular regions, the second data specifying genders associated with each of the rectangular regions of the second multitude of rectangular regions, the method comprising: for each match of a rectangular region of the first multitude of rectangular regions to a rectangular region of the second multitude of rectangular regions, comparing a gender associated with the matched rectangular region of the first multitude of rectangular regions to a gender associated with the matched rectangular region of the second multitude of rectangular regions; counting the number of matches of rectangular regions from the first and second multitudes of rectangular regions in which the associated genders differ; and calculating a gender match error from the number counted of matches in which the associated genders differ divided by the number of matches of rectangular regions.

Any of the above examples of computer-implemented method, the first data comprising a first impression count of the motion video, the second data comprising a second impression count of the motion video, the method comprising calculating an impression count error from a difference of the second impression count and the first impression count, the difference divided by the second impression count.

Any of the above examples of computer-implemented method, the first data comprising a first average dwell time for all impressions counted in the first impression count, the second data comprising a second average dwell time for all impression counted in the second impression count, the method comprising calculating a dwell time error from a difference of the second average dwell time and the first average dwell time, the difference divided by the second average dwell time.

An example apparatus comprising a processor circuit and a storage communicatively coupled to the processor circuit, and storing a sequence of instructions that when executed by the processor circuit, causes the processor circuit to: receive a first signal from a first device conveying a first data specifying boundaries of a first rectangular region indicated as comprising an image of a face in a video frame of a motion video; receive a second signal from a second device conveying a second data specifying boundaries of a second rectangular region indicated as comprising an image of a face in the video frame of the motion video; measure a first distance between first corresponding corners of the first and second rectangular regions; compare the first distance to a distance threshold; and determine whether the first and second rectangular regions comprise images of a same face based on the comparison.

Either of the above examples of apparatus, the processor circuit caused to: measure a second distance between second corresponding corners of the first and second rectangular regions; compare the second distance to the distance threshold; and determine whether the first and second rectangular regions comprise images of a same face based on the comparisons of the first and second distances to the distance threshold.

Any of the above examples of apparatus, the apparatus comprising a testing controller, the first device comprising a video analytics system, the first data specifying boundaries of a first multitude of rectangular regions indicated as comprising images of faces in the motion video, the first multitude of rectangular regions comprising the first rectangular region, the processor circuit caused to transmit the motion video to the first device.

Any of the above examples of apparatus, the apparatus comprising a display and the second device, the second device comprising an input device operable by a test support person viewing the display, the second data specifying boundaries of a second multitude of rectangular regions indicated as comprising images of faces in the motion video, the second multitude of rectangular regions comprising the second rectangular region, the processor circuit caused to visually present video frames of the motion video on the display.

Any of the above examples of apparatus, the processor circuit caused to: match rectangular regions of the first multitude of rectangular regions to rectangular regions of the second multitude of rectangular regions; count a number of rectangular regions of the first multitude of rectangular regions that cannot be matched to a rectangular region of the second multitude of rectangular regions; count a number of rectangular regions of the second multitude of rectangular regions that cannot be matched to a rectangular region of the first multitude of rectangular regions; calculate a false positive error of the first device from the number counted of rectangular regions of the first multitude of rectangular regions that cannot be matched to a rectangular region of the second multitude of rectangular regions; and calculate a false negative error of the first device from the number counted of rectangular regions of the second multitude of rectangular regions that cannot be matched to a rectangular region of the first multitude of rectangular regions.

Any of the above examples of apparatus, the processor circuit caused to measure a track distance from the center of each matched rectangular region of the first multitude of rectangular regions to the center of each matching rectangular region of the second multitude of rectangular regions; and calculate a track match error of the first device from a total of all of the tracking distances divided by the number of matches of rectangular regions.

Any of the above examples of apparatus, the first data specifying ages associated with each of the rectangular regions of the first multitude of rectangular regions, the second data specifying ages associated with each of the rectangular regions of the second multitude of rectangular regions, the processor circuit caused to: for each match of a rectangular region of the first multitude of rectangular regions to a rectangular region of the second multitude of rectangular regions, compare an age associated with the matched rectangular region of the first multitude of rectangular regions to an age associated with the matched rectangular region of the second multitude of rectangular regions; count the number of matches of rectangular regions from the first and second multitudes of rectangular regions in which the associated ages differ; and calculate an age match error from the number counted of matches in which the associated ages differ divided by the number of matches of rectangular regions.

Any of the above examples of apparatus, the first data specifying genders associated with each of the rectangular regions of the first multitude of rectangular regions, the second data specifying genders associated with each of the rectangular regions of the second multitude of rectangular regions, the processor circuit caused to: for each match of a rectangular region of the first multitude of rectangular regions to a rectangular region of the second multitude of rectangular regions, compare a gender associated with the matched rectangular region of the first multitude of rectangular regions to a gender associated with the matched rectangular region of the second multitude of rectangular regions; count the number of matches of rectangular regions from the first and second multitudes of rectangular regions in which the associated genders differ; and calculate a gender match error from the number counted of matches in which the associated genders differ divided by the number of matches of rectangular regions.

Any of the above examples of apparatus, the first data comprising a first impression count of the motion video, the second data comprising a second impression count of the motion video, the processor circuit caused to calculate an impression count error from a difference of the second impression count and the first impression count, the difference divided by the second impression count.

Any of the above examples of apparatus, the first data comprising a first average dwell time for all impressions counted in the first impression count, the second data comprising a second average dwell time for all impression counted in the second impression count, the processor circuit caused to calculate a dwell time error from a difference of the second average dwell time and the first average dwell time, the difference divided by the second average dwell time.

An example of at least one machine-readable storage medium comprising a plurality of instructions that when executed by a computing device, causes the computing device to: receive a first signal from a first device conveying a first data specifying boundaries of a first rectangular region indicated as comprising an image of a face in a video frame of a motion video; receive a second signal from a second device conveying a second data specifying boundaries of a second rectangular region indicated as comprising an image of a face in the video frame of the motion video; measure a first distance between first corresponding corners of the first and second rectangular regions; compare the first distance to a distance threshold; and determine whether the first and second rectangular regions comprise images of a same face based on the comparison.

The above example of at least one machine-readable storage medium, the computing device caused to: measure a second distance between second corresponding corners of the first and second rectangular regions; compare the second distance to the distance threshold; and determine whether the first and second rectangular regions comprise images of a same face based on the comparisons of the first and second distances to the distance threshold.

Either of the above examples of at least one machine-readable storage medium, the computing device caused to: match rectangular regions of the first multitude of rectangular regions to rectangular regions of the second multitude of rectangular regions; count a number of rectangular regions of the first multitude of rectangular regions that cannot be matched to a rectangular region of the second multitude of rectangular regions; count a number of rectangular regions of the second multitude of rectangular regions that cannot be matched to a rectangular region of the first multitude of rectangular regions; calculate a false positive error of the first device from the number counted of rectangular regions of the first multitude of rectangular regions that cannot be matched to a rectangular region of the second multitude of rectangular regions; and calculate a false negative error of the first device from the number counted of rectangular regions of the second multitude of rectangular regions that cannot be matched to a rectangular region of the first multitude of rectangular regions.

Any of the above examples of at least one machine-readable storage medium, the computing device caused to measure a track distance from the center of each matched rectangular region of the first multitude of rectangular regions to the center of each matching rectangular region of the second multitude of rectangular regions; and calculate a track match error of the first device from a total of all of the tracking distances divided by the number of matches of rectangular regions.

Any of the above examples of at least one machine-readable storage medium, the computing device caused to calculate an impression count error from a difference of the second impression count and the first impression count, the difference divided by the second impression count, the first data comprising a first impression count of the motion video, the second data comprising a second impression count of the motion video.

Any of the above examples of at least one machine-readable storage medium, the computing device caused to calculate a dwell time error from a difference of the second average dwell time and the first average dwell time, the difference divided by the second average dwell time, the first data comprising a first average dwell time for all impressions counted in the first impression count, the second data comprising a second average dwell time for all impression counted in the second impression count.

1. A computer-implemented method comprising:
transmitting a motion video to a first device;
receiving a first signal from the first device conveying a first data specifying boundaries of a first rectangular region indicated as comprising an image of a face in a video frame of the motion video;
receiving a second signal from a second device conveying a second data specifying boundaries of a second rectangular region indicated as comprising an image of a face in the video frame of the motion video;
measuring a first distance between first corresponding corners of the first and second rectangular regions;
comparing the first distance to a distance threshold; and
determining whether the first and second rectangular regions comprise images of a same face based on the comparison.

2. The computer-implemented method of claim 1, comprising:
measuring a second distance between second corresponding corners of the first and second rectangular regions;
comparing the second distance to the distance threshold; and
determining whether the first and second rectangular regions comprise images of a same face based on the comparisons of the first and second distances to the distance threshold.

3. The computer-implemented method of claim 1, the first data specifying boundaries of a first multitude of rectangular regions indicated as comprising images of faces in the motion video, the first multitude of rectangular regions comprising the first rectangular region.

4. The computer-implemented method of claim 3, comprising visually presenting video frames of the motion video on a display, the second device comprising an input device operable by a test support person viewing the video frames visually presented on the display, the second data specifying boundaries of a second multitude of rectangular regions indicated as comprising images of faces in the motion video, the second multitude of rectangular regions comprising the second rectangular region.

5. The computer-implemented method of claim 1, comprising:
matching rectangular regions of the first multitude of rectangular regions to rectangular regions of the second multitude of rectangular regions;
counting a number of rectangular regions of the first multitude of rectangular regions that cannot be matched to a rectangular region of the second multitude of rectangular regions;
counting a number of rectangular regions of the second multitude of rectangular regions that cannot be matched to a rectangular region of the first multitude of rectangular regions;
calculating a false positive error of the first device from the number counted of rectangular regions of the first multitude of rectangular regions that cannot be matched to a rectangular region of the second multitude of rectangular regions; and
calculating a false negative error of the first device from the number counted of rectangular regions of the second multitude of rectangular regions that cannot be matched to a rectangular region of the first multitude of rectangular regions.

6. The computer-implemented method of claim 5, comprising:
measuring a track distance from the center of each matched rectangular region of the first multitude of rectangular regions to the center of each matching rectangular region of the second multitude of rectangular regions; and
calculating a track match error of the first device from a total of all of the tracking distances divided by the number of matches of rectangular regions.

7. The computer-implemented method of claim 5, the first data specifying ages associated with each of the rectangular regions of the first multitude of rectangular regions, the second data specifying ages associated with each of the rectangular regions of the second multitude of rectangular regions, the method comprising:
for each match of a rectangular region of the first multitude of rectangular regions to a rectangular region of the second multitude of rectangular regions, comparing an age associated with the matched rectangular region of the first multitude of rectangular regions to an age associated with the matched rectangular region of the second multitude of rectangular regions;
counting the number of matches of rectangular regions from the first and second multitudes of rectangular regions in which the associated ages differ; and
calculating an age match error from the number counted of matches in which the associated ages differ divided by the number of matches of rectangular regions.

8. The computer-implemented method of claim 5, the first data specifying genders associated with each of the rectangular regions of the first multitude of rectangular regions, the second data specifying genders associated with each of the rectangular regions of the second multitude of rectangular regions, the method comprising:
for each match of a rectangular region of the first multitude of rectangular regions to a rectangular region of the second multitude of rectangular regions, comparing a gender associated with the matched rectangular region of the first multitude of rectangular regions to a gender associated with the matched rectangular region of the second multitude of rectangular regions;
counting the number of matches of rectangular regions from the first and second multitudes of rectangular regions in which the associated genders differ; and
calculating a gender match error from the number counted of matches in which the associated genders differ divided by the number of matches of rectangular regions.

9. The computer-implemented method of claim 1, the first data comprising a first impression count of the motion video, the second data comprising a second impression count of the motion video, the method comprising calculating an impression count error from a difference of the second impression count and the first impression count, the difference divided by the second impression count.

10. The computer-implemented method of claim 9, the first data comprising a first average dwell time for all impressions counted in the first impression count, the second data comprising a second average dwell time for all impression counted in the second impression count, the method comprising calculating a dwell time error from a difference of the second average dwell time and the first average dwell time, the difference divided by the second average dwell time.

11. An apparatus comprising:
a processor circuit; and
a storage communicatively coupled to the processor circuit, and storing a sequence of instructions that when executed by the processor circuit, causes the processor circuit to:
receive a first signal from a first device conveying a first data specifying boundaries of a first rectangular region indicated as comprising an image of a face in a video frame of a motion video;
receive a second signal from a second device conveying a second data specifying boundaries of a second rectangular region indicated as comprising an image of a face in the video frame of the motion video;
measure a first distance between first corresponding corners of the first and second rectangular regions;
compare the first distance to a distance threshold; and
determine whether the first and second rectangular regions comprise images of a same face based on the comparison.

12. The apparatus of claim 11, the processor circuit caused to:
measure a second distance between second corresponding corners of the first and second rectangular regions;
compare the second distance to the distance threshold; and
determine whether the first and second rectangular regions comprise images of a same face based on the comparisons of the first and second distances to the distance threshold.

13. The apparatus of claim 11, the apparatus comprising a testing controller, the first device comprising a video analytics system, the first data specifying boundaries of a first multitude of rectangular regions indicated as comprising images of faces in the motion video, the first multitude of rectangular regions comprising the first rectangular region, the processor circuit caused to transmit the motion video to the first device.

14. The apparatus of claim 13, the apparatus comprising a display and the second device, the second device comprising an input device operable by a test support person viewing the display, the second data specifying boundaries of a second multitude of rectangular regions indicated as comprising images of faces in the motion video, the second multitude of rectangular regions comprising the second rectangular region, the processor circuit caused to visually present video frames of the motion video on the display.

15. The apparatus of claim 11, the processor circuit caused to:
match rectangular regions of the first multitude of rectangular regions to rectangular regions of the second multitude of rectangular regions;
count a number of rectangular regions of the first multitude of rectangular regions that cannot be matched to a rectangular region of the second multitude of rectangular regions;
count a number of rectangular regions of the second multitude of rectangular regions that cannot be matched to a rectangular region of the first multitude of rectangular regions;
calculate a false positive error of the first device from the number counted of rectangular regions of the first multitude of rectangular regions that cannot be matched to a rectangular region of the second multitude of rectangular regions; and
calculate a false negative error of the first device from the number counted of rectangular regions of the second multitude of rectangular regions that cannot be matched to a rectangular region of the first multitude of rectangular regions.

16. The apparatus of claim 15, the processor circuit caused to:
measure a track distance from the center of each matched rectangular region of the first multitude of rectangular regions to the center of each matching rectangular region of the second multitude of rectangular regions; and
calculate a track match error of the first device from a total of all of the tracking distances divided by the number of matches of rectangular regions.

17. The apparatus of claim 15, the first data specifying ages associated with each of the rectangular regions of the first multitude of rectangular regions, the second data specifying ages associated with each of the rectangular regions of the second multitude of rectangular regions, the processor circuit caused to:
for each match of a rectangular region of the first multitude of rectangular regions to a rectangular region of the second multitude of rectangular regions, compare an age associated with the matched rectangular region of the first multitude of rectangular regions to an age associated with the matched rectangular region of the second multitude of rectangular regions;
count the number of matches of rectangular regions from the first and second multitudes of rectangular regions in which the associated ages differ; and
calculate an age match error from the number counted of matches in which the associated ages differ divided by the number of matches of rectangular regions.

18. The apparatus of claim 15, the first data specifying genders associated with each of the rectangular regions of the first multitude of rectangular regions, the second data specifying genders associated with each of the rectangular regions of the second multitude of rectangular regions, the processor circuit caused to:
for each match of a rectangular region of the first multitude of rectangular regions to a rectangular region of the second multitude of rectangular regions, compare a gender associated with the matched rectangular region of the first multitude of rectangular regions to a gender associated with the matched rectangular region of the second multitude of rectangular regions;
count the number of matches of rectangular regions from the first and second multitudes of rectangular regions in which the associated genders differ; and
calculate a gender match error from the number counted of matches in which the associated genders differ divided by the number of matches of rectangular regions.

19. The apparatus of claim 11, the first data comprising a first impression count of the motion video, the second data comprising a second impression count of the motion video, the processor circuit caused to calculate an impression count error from a difference of the second impression count and the first impression count, the difference divided by the second impression count.

20. The apparatus of claim 11, the first data comprising a first average dwell time for all impressions counted in the first impression count, the second data comprising a second average dwell time for all impression counted in the second impression count, the processor circuit caused to calculate a dwell time error from a difference of the second average dwell time and the first average dwell time, the difference divided by the second average dwell time.

21. At least one machine-readable storage medium comprising a plurality of instructions that when executed by a computing device, causes the computing device to:
receive a first signal from a first device conveying a first data specifying boundaries of a first rectangular region indicated as comprising an image of a face in a video frame of a motion video;
receive a second signal from a second device conveying a second data specifying boundaries of a second rectangular region indicated as comprising an image of a face in the video frame of the motion video;
measure a first distance between first corresponding corners of the first and second rectangular regions;
measure a second distance between second corresponding corners of the first and second rectangular regions;
compare the first and second distances to a distance threshold; and
determine whether the first and second rectangular regions comprise images of a same face based on the comparisons.

22. The machine-readable storage medium of claim 21, the computing device caused to:
match rectangular regions of the first multitude of rectangular regions to rectangular regions of the second multitude of rectangular regions;
count a number of rectangular regions of the first multitude of rectangular regions that cannot be matched to a rectangular region of the second multitude of rectangular regions;
count a number of rectangular regions of the second multitude of rectangular regions that cannot be matched to a rectangular region of the first multitude of rectangular regions;
calculate a false positive error of the first device from the number counted of rectangular regions of the first multitude of rectangular regions that cannot be matched to a rectangular region of the second multitude of rectangular regions; and
calculate a false negative error of the first device from the number counted of rectangular regions of the second multitude of rectangular regions that cannot be matched to a rectangular region of the first multitude of rectangular regions.

23. The machine-readable storage medium of claim 22, the computing device caused to:
measure a track distance from the center of each matched rectangular region of the first multitude of rectangular regions to the center of each matching rectangular region of the second multitude of rectangular regions; and
calculate a track match error of the first device from a total of all of the tracking distances divided by the number of matches of rectangular regions.

24. The machine-readable storage medium of claim 22, the computing device caused to calculate an impression count error from a difference of the second impression count and the first impression count, the difference divided by the second impression count, the first data comprising a first impression count of the motion video, the second data comprising a second impression count of the motion video.

25. The machine-readable storage medium of claim 24, the computing device caused to calculate a dwell time error from a difference of the second average dwell time and the first average dwell time, the difference divided by the second average dwell time, the first data comprising a first average dwell time for all impressions counted in the first impression count, the second data comprising a second average dwell time for all impression counted in the second impression count.
